(19) United States
(12) Patent Application Publication
(10) Pub. No.: US 2005/0144018 A9
(43) Pub. Date: Jun. 30, 2005

(54) Property verification products and methods

(76) Inventor: Larry Aptekar, Bellaire, TX (US)

Correspondence Address: Larry Aptekar, 9822 Harwin Dr., Houston, TX, 77036, US

(21) Appl. No.: 10/439,142

(22) Filed: May 15, 2003

(51) Int. Cl. G06F 17/60

(52) U.S. Cl. 705/1

(57) ABSTRACT

A documentation product and methods for using the product to check rental property and take responsibility for the rental property are disclosed. The documentation product includes a rental document that corresponds to a rental transaction. The rental document includes identification of a rental company, identification of a renter, and identification of an image. The identified image depicts the property. The identified image can be compared to the returned property such that discrepancies can be determined. The rental document can also be acknowledged as corresponding to the property depicted at least in part by the image.

### FIELD OF THE INVENTION

This invention relates generally to documents used in rental and related transactions, and more particularly to photographic documentation and verification wherein photographs or images of the property that is the subject of the transaction are associated with physical documents used in the rental or related transactions for purposes of identification, authentication, verification or confirmation of the transaction or condition of the property.

### BACKGROUND

Documents and forms known as rental agreements are used when a rental company rents property such as a motor vehicle to a renter. The renter usually wants to use the property for relatively short time period (e.g., a day, a week, or a month).

A rental agreement is a document issued by a rental company that evidences the receipt of the property for subsequent use by the renter. The rental agreement names the rental company and the renter. The rental agreement describes the rental fee arrangement and often the insurance options. Furthermore it describes, in written words, the property that is being rented. At times a sketch of the property being rented is included along with a system for marking the location and type of damage which the personal property may have at the time of start of the rental period. When the personal property is returned, the rental company personnel compare the condition of the property being returned to the condition described in words and/or to the sketch contained in the original rental agreement in order to assess whether any damage occurred to the property during the rental period. If there is additional damage, the renter (or the renter's insurance company) is usually responsible for the repair costs.

One problem with conventional rental agreements and other documents and forms used in rental transactions is that they only provide a written description of the rental property (and any damage to it) and/or only a rough sketch of the property indicating the location and extent of any damage. These types of documents and forms can be subject to accidental mistakes in describing the condition of the property involved in the transaction. They are also subjective in nature. At times pre-existing damage may not be noted. At other times, the location (and/or extent) of the damage may be improperly noted on the rental agreement.

Thus, based on the written description and/or sketch alone, it is possible that the personnel of the rental company won't recognize if the property has been damaged during the rental period. Recognizing new damage to property is an ongoing problem in the rental industry. Renters are also often anxious before acknowledging the specific condition of rental property on a rental agreement. This is because they are worried that the personnel of the rental company might not note some existing damage to the property. If this happens, the renter is concerned that he may be charged for that damage upon returning the property. However, it would be better if photographs of the vehicle are taken at the time of the start of the rental (particularly in the presence of the renter). In this way, the renter and the personnel of the rental company (who are also concerned about accurately listing all damage) would be more confident that the exact condition of the vehicle has been accurately established.

Furthermore, renters might want to return the property being rented at a location or at a time where no one representing the rental company is available to assess the property's condition. Renters who do this run the risk of getting billed for damage to the rental property that they were not responsible for. Rental companies sometimes accept returns in this way in order to control labor costs. However, they then face the problem of proving that the renter was responsible for any new damage. If the renter would be able to obtain photographs of the property at the time of its return, it would provide clear proof of the condition of the property. Thus the renter could confidently drop off the property at specially designed areas which had cameras available to take photographic images of the property. This system would provide proof of the condition of the property in the event of a dispute, particularly if the renter was able to obtain a receipt containing the photographic images before leaving the premises. This new system would also encourage rental companies to set up these special areas for returns. Ideally these areas would have one or more pre-mounted cameras which can be activated with a single push of a button (or click of a computer mouse). Not only can digital still cameras be used for this purpose, but also a video camera which follows a path around the property might also be used. Furthermore, the rental company might also decide to remotely monitor and assist the renter with the return.

For rental companies, competition is an ongoing problem. So maintaining a professional image is very important. However, using words and sketches to describe rental property when full-color photographs are available, make the rental companies look old-fashioned and less sophisticated in technological matters. So using photographs would tend to enhance the image of the rental companies.

### SUMMARY

Implementations of the present invention overcome the stated problems by identifying in the rental documents image information corresponding to the property being rented. No one of the above-discussed problems is critical and different implementations of the inventions may solve different problems.

In general, in one aspect, the invention features a documentation product. The documentation product includes a rental document that corresponds to a rental transaction. The rental document includes identification of a rental company, identification of a renter, and identification of an image. The identified image depicts the property. Uses of the documentation product include, but are not limited to, identifying prior condition of the property at the time of the return of the property.

In general, in another aspect, the invention features a method of checking the condition of the rental property. The method includes viewing a rental document that has identification of an image depicting the property. The property is viewed. The image is viewed. The property is compared to the image such that discrepancies can be determined. The method can be used for many purposes including, but not limited to, determining whether damage has occurred during the rental period.

In general, in another aspect, the invention features a method of taking responsibility for the property's condition. The method includes obtaining the property. A rental document that includes identification of an image depicting the property is also obtained. The rental document is then acknowledged. The method can be used for many purposes including, but not limited to, defining the liability risk to which a renter is subject, supplementing a sketch of the property, and supplementing a textual description of the property.

### BRIEF DESCRIPTION OF THE DRAWINGS

FIG. 1 is an elevation view of the front side of a preferred embodiment of a rental document in accordance with an implementation of the present invention.

FIG. 2 is an elevation view of the front side of a preferred embodiment of a return receipt in accordance with an implementation of the present invention.

FIG. 3 is an elevation view of the front side of a preferred embodiment of a supplemental photographic rental receipt form in accordance with an implementation of the present invention.

FIG. 4 is a flowchart showing schematically an example of how a rental agreement with an implementation of the present invention is used in a rental transaction.

### DESCRIPTION OF THE PREFERRED EMBODIMENTS

Rental Agreement

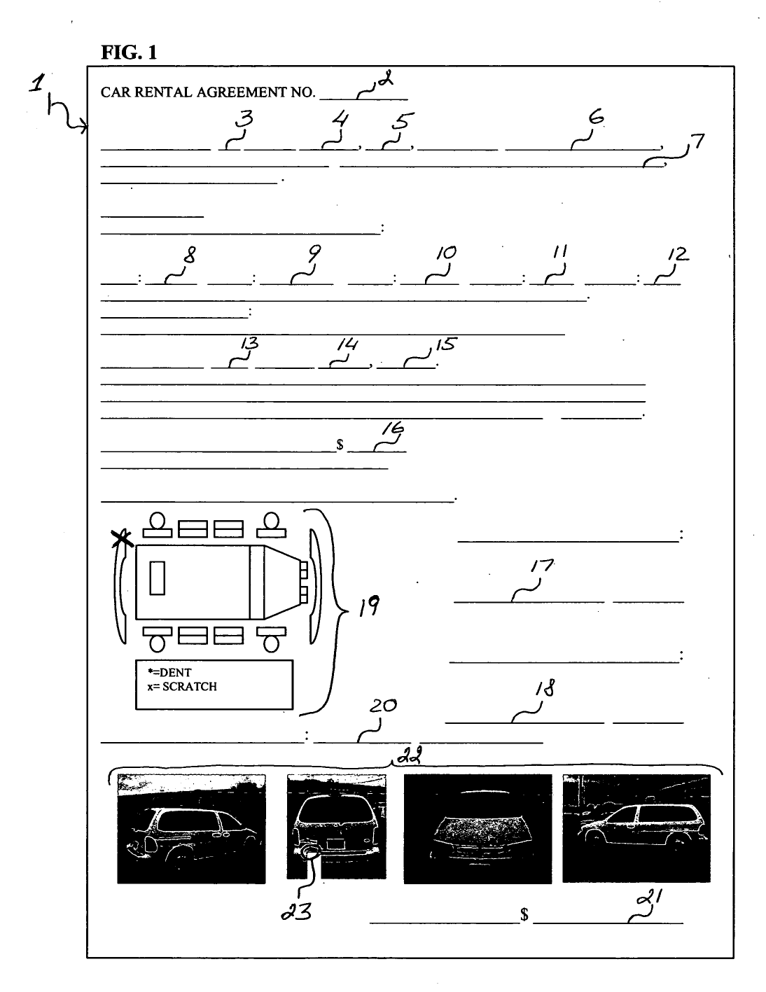

Referring now to the drawings by numerals of reference, there is shown in FIG. 1, an example of a rental agreement 1 in accordance with an implementation of the present invention. The rental agreement 1 is a printed paper document issued by a rental company that evidences the receipt of personal property for rental by the renter.

The rental agreement 1 is a printed form having the following sections, which are filled in by handwritten or typed words and numerals (or is computer generated): the rental agreement number 2, the day the rental agreement begins 3, the month the rental agreement begins 4, the year the rental agreement begins 5, the name of the rental company 6, the renter 7, the vehicle color 8, the vehicle license number 9, the vehicle make 10, the vehicle model 11, the mileage of the vehicle 12, the ending day of the rental 13, the ending month of the rental 14, the ending year of the rental 15, the rental rate 16, the signature of the renter 17, the signature of an authorized employee of the rental company 18, a sketch of the rental prpoperty 19, and the signature (or initials) of the renter indicating acceptance of the condition of the property as shown in the rental agreement 20, and the final charges due from the renter 21.

In addition to the sections described above, the rental agreement form 1 of an implementation of the present invention also has a section that includes one or more photographic images 22 of the vehicle being rented and a mark on one or more of the photographic images indicating existing damage 23.

In a preferred embodiment, the photographic images are taken with a digital color camera and downloaded to a computer (or connected to a computer for subsequent file retrieval). Alternatively, the photographic images are taken with a film color camera, developed, and scanned into a computer. If the document is a preprinted form, the images can be printed onto the form, onto a label, or supplemental pages, that is/are then affixed or attached to the form. If the document is available as a template on a word processing program, the images can be electronically cut and pasted into the appropriate section of the document via the word processor. Afterwards the whole document, with additional pages as needed, is printed. The photographic images 22 are placed on the rental agreement by the rental company. When the renter is about to take possession of the vehicle, he compares the photographic images on the rental agreement to the vehicle. When he is satisfied he signs the rental agreement. The rental company gives the renter a copy of the rental agreement and might store the images on their computer system (or post them to a web site). In this way they will be readily available to other personnel who work for the rental company at the same or a different location. When the renter returns the vehicle, the personnel of the rental company compare the vehicle to the photographic images 22 in the rental agreement in order to detect any new damage. The rental company personnel would then accept the return and collect the final amount due from the renter.

Thus, the present rental agreement provides both the rental company and the renter with specific proof of the exact physical condition of the property at the time the rental began. It allows the rental company to more readily detect damage which occurred during the rental period.

Because “a picture is worth a thousand words”, it should be understood, that depending upon the detail and content of the photographic images, that the written description and/or the sketch of the vehicle may be both either be eliminated or have fewer details.

The present invention is discussed herein in reference to motor vehicle rental transactions, not as a means of limitation, but rather is intended to be exemplary of the invention utility. One skilled in the art will readily appreciate the applicability of the present invention to the verification of condition in other rental or leasing transaction contexts illustratively including those related to: boats, cargo containers, forklifts, heavy machinery, hotel rooms, trucks, trailers, and real property.

Return Receipt System

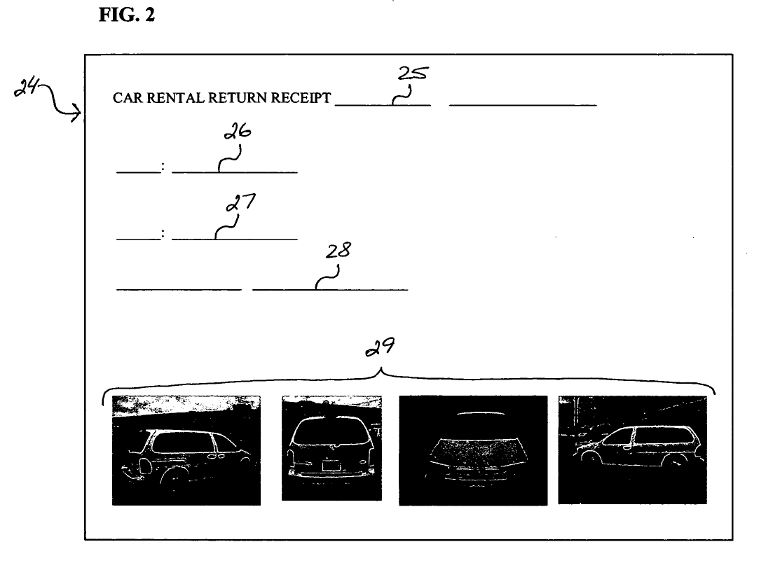

With rental companies trying to cut labor costs, they might want to allow renters who want to return the property being rented at a location or at a time where no one representing the rental company is available to assess the property's condition. However, if the renter would be able to obtain photographs of the property at the time of its return, it would provide clear proof of the condition of the property at that time. Thus the renter could confidently drop off the property at specially designed areas which had cameras available to take photographic images of the property 29 which would provide proof of the condition of the property in the event of a dispute. This would be particularly the case if the renter was able to obtain a return receipt 24 containing the photographic images 29 before leaving the premises as shown in FIG. 2. This receipt 24 contains sections containing the name of the rental company 25, the date 26, the time 27, the rental agreement number 28, and photographs of the property being returned 29.

Supplemental Photographic Receipt System

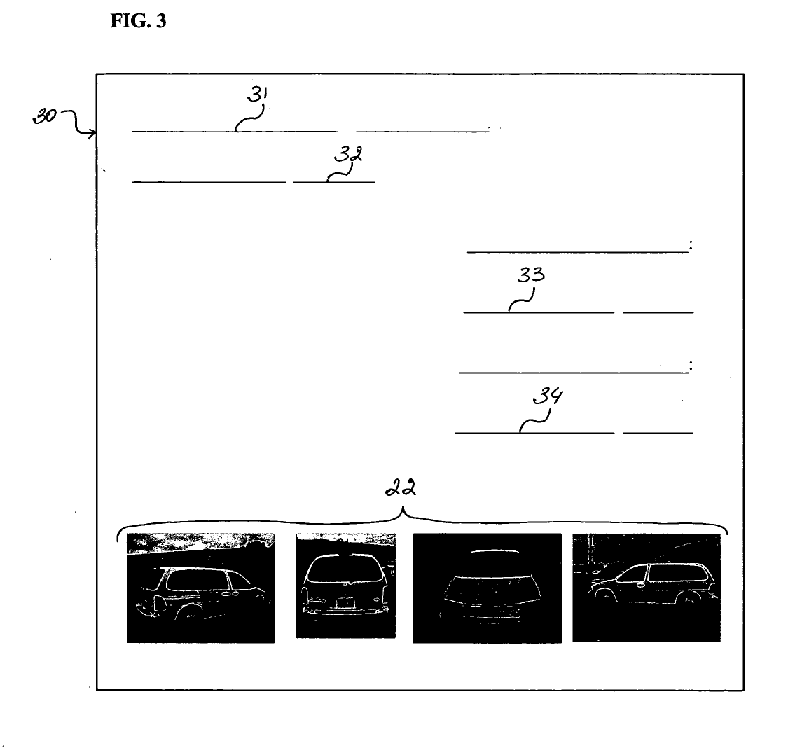

For various reasons, rental companies might prefer to continue to use the traditional documents that they currently use in rental transactions while still enjoying the benefits of the invention described herein. This can be accomplished by a system whereby the rental company prepares a traditional rental agreement and also a supplemental photographic receipt 30, as shown in FIG. 3. The photographic receipt 30, includes words or alphanumeric or other data such as rental company name 31, rental agreement number 32, and a section bearing one or more photographic images 22 of the vehicle. A receipt section to be signed by the rental company 34 and a receipt section to be signed by the renter 33 may optionally be included.

In a preferred embodiment, the renter (after comparing the photographs to the actual property) would sign this supplemental receipt 30 (just as he signs the rental agreement). The rental company can also sign the supplemental receipt 30.

Similar photographic receipts can be used in conjunction with other traditional rental-related documents.

### Operation

Rental Agreement Example

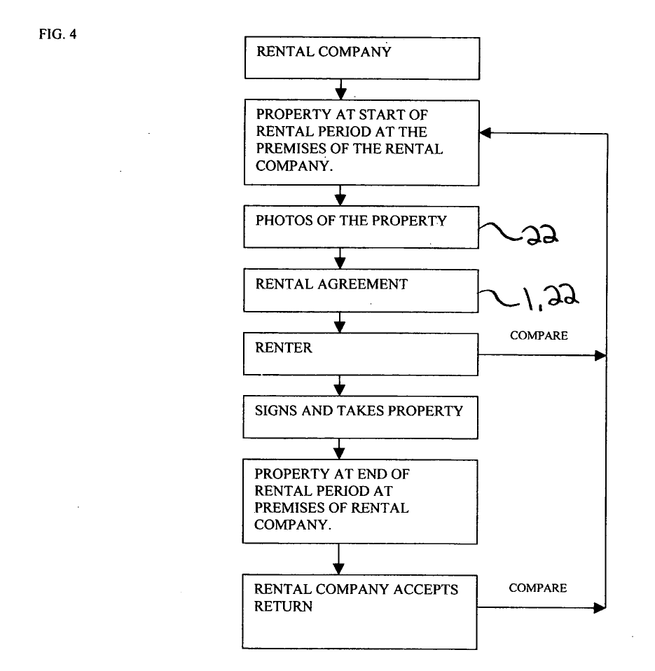

FIG. 4 is a flowchart showing schematically an example of a rental agreement in accordance with an implementation of the present invention is used in a rental transaction.

After the property is prepared for rental, the photographic images 22 are placed on the rental agreement 1, as described herein, by the rental company. The rental company might also add markings indicating existing damage to the property 23. When the renter is ready to leave the rental company's premises with the property, he compares the photographic images 22 on the rental agreement 1 to the actual property. When he is satisfied he signs the rental agreement 1 and takes the property. At the end of the rental period, the renter returns to the premises of the rental company. The personnel of the rental company would then compare the property to the photographic images 22 on rental agreement in order to detect any new damage before accepting the return of the property. If new damage is found, then the renter (and/or the renter's insurance company) will be responsible for the cost of the repair of the property.

Thus, the present rental agreement 1 provides the rental company and the renter with proof of what types of damage and the location of damage that existed at the time of the start of the rental period. It also both the rental company and the renter to more readily detect additional damage which may have occurred during the rental period. The above-described types of documents are referred to herein as types of rental documents.

The image used in the above-described documents can be identified in a number of ways. In addition to having the image included on the rental document, the rental document can identify another document that contains the image and that document can be attached or separate from the rental document. The rental agreement can also identify the image by specifying a location of data that represents the image. Such data could include a particular storage device (e.g., a disk, CD or flash memory), a storage location on a data network (e.g., a URL on the Internet), or a particular entity that holds the data. A particular entity can also hold actual images rather than data representing an image.

While this invention has been described fully and completely with special emphasis upon preferred embodiments, it should be understood that there are other implementations within the scope of the appended claims.

1. A documentation product comprising:
a rental document corresponding to a rental transaction, wherein the rental document includes at least:
(a) identification of a rental company;
(b) identification of a renter; and
(c) identification of an image;
wherein the image depicts the rented property.

2. The documentation product of claim 1, wherein the identification of the image comprises the image.

3. The documentation product of claim 1, wherein the identification of the image comprises identification of a second document attached to the rental document.

4. The documentation product of claim 1, wherein the identification of the image comprises identification of a location where data representing the image is stored.

5. The documentation product of claim 1, wherein the identification of the image comprises identification of an entity that has possession of the image.

6. The documentation product of claim 1, wherein the rental document further includes a textual description of the property.

7. The documentation product of claim 1, wherein the rental document further includes a sketch of the property indicating any damage to it.

8. The documentation product of claim 1, wherein the rental transaction is a portion of a second rental transaction.

9. The documentation product of claim 1, wherein the identification of the renter comprises a rental agreement number.

10. The documentation product of claim 1, wherein the image which depicts the rented property has at least one added marking indicating a location where damage is present.

11. The documentation product of claim 1 wherein the image which depicts the rented property is generated from one or more pre-mounted cameras positioned to take photographs of the rented property.

12. The documentation product of claim 1, wherein the rental document is electronic.

13. A method of checking the condition of rental property, comprising the steps of:
viewing a rental document that includes identification of an image depicting the property;
viewing the property;
viewing the image; and
comparing the property to the image such that discrepancies can be determined.

14. The method of claim 13, wherein the rental property includes a vehicle and further comprising the step of:
obtaining the keys to the vehicle.

15. The method of claim 13, further comprising the step of:
determining one or more discrepancies between the property and the image.

16. The method of claim 13, further comprising the step of:
determining that there are no discrepancies between the property and the image.

17. The method of claim 13, wherein the identification of the image comprises the image.

18. The method of claim 13, wherein the identification of the image comprises identification of a second document attached to the rental document.

19. The method of claim 13, wherein the identification of the image comprises identification of a location where data representing the image is stored.

20. The method of claim 13, wherein the identification of the image comprises identification of an entity that has possession of the image.

21. The method of claim 13, wherein the rental document further includes a textual description of the property, and further comprising the step of:
comparing the property to the textual description such that discrepancies can be determined.

22. The method of claim 13, wherein the rental document further includes a sketch of the property indicating any damage to it, and further comprising the step of:
comparing the property to the sketch such that discrepancies can be determined.

23. The method of claim 13, wherein the rental transaction is a portion of a second rental transaction.

24. The method of claim 13, wherein the step of viewing the property includes remotely viewing the property.

25. The method of claim 13, wherein the step of viewing the property includes viewing a second image of the property.

26. The method of claim 13, further comprising the step of:
obtaining the rental document.

27. The method of claim 13, further comprising the step of:
preparing the rental document.

28. The method of claim 13, where viewing the image includes viewing a marking added to the image to indicate the specific location of damage.

29. A method of taking responsibility for rental property, comprising the steps of:
obtaining the property;
obtaining a rental document that includes identification of an image depicting the property;
and acknowledging the rental document.

30. The method of claim 28, further comprising the steps of:
determining one or more discrepancies between the property and the image; and
recording the discrepancies on the rental document prior to the step of acknowledging.

31. The method of claim 29, further comprising the step of:
determining that there are no discrepancies between the property and the image.

32. The method of claim 29, wherein the identification of the image comprises the image.

33. The method of claim 29, wherein the identification of the image comprises identification of a second document attached to the rental document.

34. The method of claim 29, wherein the identification of the image comprises identification of a location where data representing the image is stored.

35. The method of claim 29, wherein the identification of the image comprises identification of an entity that has possession of the image.

36. The method of claim 29, wherein the rental document further includes a textual description of the property.

37. The method of claim 29, wherein the rental document further includes a sketch of the property indicating any damage to it.

38. The method of claim 29, wherein the step of acknowledging the rental document includes signing the rental document.

39. The method of claim 29, wherein the step of acknowledging the rental document includes accepting payment from the renter.

40. The method of claim 29, wherein the rental transaction is a portion of a second rental transaction.

41. The method of claim 29, wherein the rental property includes a vehicle and further comprising the step of:
receiving the keys to the vehicle.
